(19) United States
(12) Patent Application Publication
(10) Pub. No.: US 2021/0247279 A1
(43) Pub. Date: Aug. 12, 2021

(54) TISSUE SAMPLING

(71) Applicant: Genomics England Limited, London Greater London (GB)

(72) Inventor: Clare Craig, London Greater London (GB)

(21) Appl. No.: 17/053,624

(22) PCT Filed: May 8, 2019
(86) PCT No.: PCT/GB19/51260

§ 371 Date: Nov. 6, 2020

(30) Foreign Application Priority Data
May 8, 2018 (GB) 1807493.0

(51) Int. Cl. G01N 1/40; G01N 1/30

(52) U.S. Cl. CPC G01N 1/4077; G01N 2001/305; G01N 1/30; G01N 1/4055

(57) ABSTRACT

The present invention relates to methods for sampling fresh whole cells from a solid tissue sample, for example for use in diagnostic methods. The method comprises releasing cells from a solid tissue sample into a solution, separating at least a proportion of the solution from the solid tissue sample, and retaining solution separated from the solid tissue sample. Due to the gentle nature in which the cells are released from the periphery tissue sample into solution, the core tissue sample structure is maintained and remains suitable for conventional tissue analysis by a pathologist (for example, examination of the tissue under a microscope). The released cells can be used for a variety of applications, such as nucleic acid sequencing.

The present invention relates to methods for sampling fresh whole cells from a solid tissue sample, for example for use in diagnostic methods.

Diagnosis of cancer, for example, requires tumour tissue or cells, for a variety of laboratory processes. Genetic testing of tumours is increasingly becoming an important part of cancer diagnosis and treatment. It is desirable to carry out sequencing of tumour DNA in order to identify specific mutations, thereby enabling a more specific or definitive diagnosis. In some cases, knowledge of specific mutations also allows a more targeted approach to treatment that is tailored to the genetic make-up of a patient's tumour. Genetic testing, such as DNA sequencing may also be carried out on tissue samples other than tumours, for example to assist in the diagnosis of other genetic disorders

Current methods of obtaining tumour DNA for sequencing comprise obtaining a biopsy or tissue from a surgical resection from a patient and then mechanically and enzymatically disrupting the sample tissue to extract DNA. One problem with this technique is that DNA yield is relatively low (of the order of about 5% of the DNA present in the tissues is extracted under some circumstances). Another problem is that the process destroys all the tissue meaning that none is available for subsequent analysis by conventional means, such as histopathological examination, which rely on the tissue structure being intact. Pathologists like to view as much as possible of the biopsies that have been taken to ensure that their diagnosis is correct and as definitive as possible. This is not possible if the tissue is destroyed for DNA extraction. On the other hand, processing and analysing samples using conventional pathology techniques damages the DNA in the sample, meaning that such samples are typically not suitable for providing DNA for whole genome sequencing. Conventionally the tissue is placed into formalin at the patient bedside. The entire tissue ends up with damaged DNA as a result. It should be noted that genetic testing is currently done on the formalin-damaged samples embedded in wax blocks. However, these are single gene tests or panels that have been adapted for this situation rather than sequencing the whole genome which cannot be interpreted in the presence of formalin damage. In summary, according to existing practices and methods, if both conventional analysis and DNA sequencing are to be carried out, separate tissue samples are required for each process.

However, clinicians are often reluctant to take more than one biopsy sample so as to avoid exposing the patient to additional risk. Biopsy sampling can also cause significant anxiety and discomfort to the patient, meaning that it is desirable to keep biopsy sampling to a minimum. In addition, it can be difficult to get two biopsies that both have a high tumour proportion within them. A second sample may be inadequate for either diagnosis or DNA extraction. Conventional analysis of biopsy samples will take priority over DNA sequencing and therefore, in many cases, DNA sequencing is not available to patients. For a significant minority of cancers, the diagnosis is not suspected at the time of the biopsy. These patients also miss out on the opportunity to have their cancer sampled for genomic testing.

Another problem with existing methods is that tissue samples for DNA extraction must be frozen in order to stop the tissue degrading and preserve the DNA until it can be extracted. Gradual freezing is problematic because the water within the cells gradually expands damaging the structures within (Karlsson & Toner, Biomaterials. 1996 February; 17(3):243-56). Snap freezing is a technique for rapidly freezing tissue and minimizes the damage to cells associated with slow freezing. However, snap freezing requires the use of liquid nitrogen which is dangerous and labour intensive to handle. Rolling snap freezing out as part of standard diagnostic biopsy sampling (as opposed to where a cancer diagnosis is highly suspected) is not feasible within existing systems without significant investment.

The present invention addresses problems associated with existing methods.

### SUMMARY OF THE INVENTION

The invention provides a method of sampling whole fresh cells from a solid tissue sample, the method comprising:
(i) releasing cells from a solid tissue sample into a solution,
(ii) separating at least a proportion of the solution from the solid tissue sample, and
(iii) retaining solution separated from the solid tissue sample.

Due to the gentle nature in which the cells are released from the periphery tissue sample into solution, the core tissue sample structure is maintained and remains suitable for conventional tissue analysis by a pathologist (for example, examination of the tissue under a microscope). The released cells can be used for a variety of applications. For example, nucleic acid can be extracted from the cells of the tissue sample and sequenced. The method therefore allows for more efficient use of tissue samples because a single tissue sample can now provide material for both sequencing, (or other methods requiring fresh cells) and conventional tissue analysis. This means that patients who only have minimal tissue sampled can still have access to sequencing methods. Moreover, where multiple tissue samples are taken from a patient's tumour, the method of the invention can be applied to each sample ensuring that cells from the sample with the highest proportion of tumour are obtained.

The Sample

The sample from which cells are released according to the method of the invention is a solid tissue sample. Such samples have a solid core of tissue. This is in contrast to samples obtained by fine needle aspiration, a technique which uses a small needle (around 0.5 mm or less in inner diameter) to collect cells from a patient by repeatedly cutting through the tissue to disrupt it and allowing material to enter the bore through capillary action.

Solid tissue samples can be taken from a subject using a variety of biopsy techniques. These include tissue sampling from the skin using a punch biopsy, or sampling from less accessible organs and tissues using an endoscope (endoscopic biopsy), a hollow needle (core needle biopsy) or by surgery (excision biopsy). Note that core needle biopsy is distinct from fine needle aspiration because the sample obtained is a core of tissue rather than a collection of cells with occasional tissue fragments. The diameter of a needle used for core needle biopsy is significantly larger than the needle used for fine needle aspiration, and is usually about 1 mm or greater, usually 2 mm in inner diameter. Such a needle is used to penetrate deeply into the tissue in one cut with the tissue filling the bore intact and being extracted whole. The present invention is applicable to any solid tissue sample containing a core of tissue of any size. In some embodiments, all of the tissue sample extracted in a biopsy procedure or other extraction technique is used in the method of the invention. In other embodiments, a proportion of an extracted sample is used in the method of the invention. Remaining fresh tissue may be kept intact for other applications (e.g. testing or research). Cells from the surface of such a sample can be dislodged into solution while the core remains substantially intact. The size of the sample may be of the order of about 0.5-2 mm in diameter and/or 5-20 mm in length. The sample may be a cube of tissue having a volume of the order of about 1 cm³. The size of the sample may be of the order of about 0.5 micrograms to about 0.5 grams in weight.

The method of the invention can be applied to all types of solid tissue sample, such as for example, heart, liver, lung, brain, spleen, kidney, pancreas, breast, umbilical cord, skin, placenta, ovary, oviduct, uterus, prostate, tonsil, thymus, oesophagus, stomach, testis, skeletal muscle, smooth muscle, small intestine, colorectal, lymph node, thyroid, adrenal, bladder, urethra, eye, and gall bladder.

The solid tissue sample may or may not be obtained from a tumour. The sample may or may not contain or comprise cancerous tissue. The invention is particularly applicable to tumour samples, but is also applicable to other tissue samples where genetic testing, e.g. DNA sequencing, is required.

Tissues samples having a greater proportion of cut surface are expected to release more cells or release cells at a higher rate than tissue samples with a lower proportion of cut surface. For example, some biopsy samples are obtained by pinching off the epithelial surface meaning that the majority of tissue is covered by an intact epithelium with no cut edge. Such tissue samples may release fewer cells than tissue samples obtained by biopsy methods that rely more heavily on cutting tissue.

In some embodiments, the solid tissue sample is not treated with any agent prior to carrying out the method of the invention. For example, the tissue sample may be placed directly into a solution for carrying out the method of the invention as soon as it is removed from a subject. Preferably the sample is not preserved or stored for any significant amount of time prior to carrying out the method. The method may be carried out as soon as possible after the tissue sample is removed from a subject. In some embodiments, the method is carried out within about 72 hours, about 48 hours, about 24 hours, about 1 hour, about 45 minutes, about 30 minutes, about 20 minutes, about 10 minutes, about 5 minutes, about 2 minutes or about 1 minute of the sample being removed from a subject. The tissue sample may or may not be chilled during the period between the tissue is removed from the subject and the method of the invention being carried out.

Releasing cells from the tissue sample

The method of the invention involves releasing cells from a solid tissue sample into a solution. This means that nucleic acid can be extracted from the released cells and the solid tissue sample can be preserved for diagnostic testing such as histological analysis. The released cells could also be used for other tests or interventions including priming antigens for immunotherapy. Importantly, the tissue sample remains intact during the method. The act of releasing the cells preferably does not disrupt the overall structure of the tissue sample. The tissue sample is preferably not homogenised, fragmented or otherwise mechanically disrupted during the step of releasing cells from the tissue and remains intact. Mechanical disruption may include the use of an implement, such as a needle or other extraction tool, disruption tool, cutting tool and the like. In an embodiment, cells are not released from the tissue sample using an aspiration technique or tool. The tissue sample is preferably not subjected to sonication, for example during the step of releasing cells from the tissue. In some embodiments, the step of releasing cells from the tissue sample does not involve the use of an enzyme, such as a proteolytic enzyme, such as trypsin or collagenase. In some embodiments, the step of releasing cells from the tissue sample does not involve the use of a tissue dissociating agent. In some embodiments, the step of releasing cells from the tissue sample does not involve the use of a tissue degrading enzyme. In some embodiments, the step of releasing cells from the tissue sample does not involve the use of a chelating agent.

The step of releasing cells from the sample is as gentle as possible, to preserve the structure of the tissue sample. The force required to release cells is relatively low, particularly from tissue samples comprising a significant proportion of cut edges. In some embodiments, the tissue sample contains tumour tissue. Tumour cells are relatively loosely attached to their surrounding cells whereas the normal cells that support the tumour are rigidly attached to each other and are not released into solution as readily. This means that, when nucleic acid is extracted from cells released from samples containing both tumour tissue and healthy tissue, the proportion of nucleic acid, e.g. DNA, in the sample derived from tumour cells (tumour purity) and not their healthy neighbours is relatively high.

The release of cells can be achieved by a variety of techniques, provided that the bulk tissue sample remains intact. Preferably, cells are released through the action of solution contacting the tissue sample. For example, cells may be released into the solution by agitating the solid tissue sample in the solution. Such agitation should be gentle to preserve the structure of the tissue sample. Alternatively or additionally, solution may be washed over the tissue sample to release cells. If solution is washed over the tissue sample, the tissue sample may or may not be substantially or completely fixed in position. In some embodiments, enzymes are not used to release cells from the tissue sample. In some embodiments, cells are released from the tissue sample solely be mechanical action, for example by agitating the sample in solution or washing solution over the sample.

The solid tissue sample may be contained in solution in a flask or sample tube, for example a flask or sample tube with a lid or stopper that creates a liquid tight seal. Suitable sample tubes include PCR tubes, universal sample tubes and microcentrifuge tubes, such as those available from Eppendorf UK Limited. Such sample tubes may be preferred if the sample is to be agitated in solution to release cells. The size of container will depend on the size of the tissue sample and volume of solution to be contained. In some embodiments, the container holds a volume of about 1 ml to about 200 ml. For example 1.5 ml sample tubes may be used.

Cells may be released from the tissue by, for example, rocking, shaking, inverting, rotating, vibrating or rolling a container containing the sample and solution. Agitation can be carried out manually or automatically. Devices for automated agitation of samples are commercially available and include laboratory vortex shakers, orbital shakers, rocking shakers, wrist action flask shakers, tube roller shakers, microtitre plate shakers and digital waving shakers.

A sufficient quantity of cells is typically released from the tissue within about 1-2 minutes of gentle agitation. It has been observed that some tissue samples continue to release cells into solution after 10 minutes of gentle agitation. The sample tissue may be agitated for at least about 30 seconds, at least about 1 minute, at least about 2 minutes, at least about 5 minutes or at least about 10 minutes. The sample may be agitated for no more than about 15 minutes, no more than about 10 minutes, or no more than about 5 minutes. The sample may be agitated for about 1 minute to about 15 minutes. Preferably, the sample is agitated for about 2 minutes to about 10 minutes. In one embodiment, the sample is agitated by inverting a sample tube containing the sample repeatedly, for example, about once per second, for example for about 1 minute. In one embodiment, the sample is agitated by inverting a sample tube containing the sample repeatedly, for example, about once per second, for example for about 2 minutes.

Preferably, agitation of the sample does not include vortexing the sample. If vortexing is used, it is preferred if the sample is vortexed at a low speed and/or for a short period of time. Vortexing may be carried out at about 400 rpm or less, about 350 rpm or less, about 300 rpm or less, about 250 rpm or less, about 200 rpm or less, or about 150 rpm or less. Vortexting may be carried out for a period of about 20 seconds or less, about 15 seconds or less, about 10 seconds or less, or about 5 seconds or less. If the vortexing speed or duration is too high, the tissue sample may not remain intact. In an embodiment, cells are released into solution by vibrating the tissue sample. Preferably, this is done for a short period of time, for example about 20 seconds or less, about 15 seconds or less, about 10 seconds or less, or about 5 seconds or less.

Cells may be released from the tissue sample by placing the sample in a chamber through which solution can be passed, for example by pump or suction means. The flow rate may be controlled so as to ensure that the bulk of the tissue sample remains intact. For example, the flow rate may be in the range of about 5-30 ml per second. The tissue sample could be retained in position by any suitable means. For example, the chamber may be provided with a physical barrier for restricting the movement of the tissue sample while allowing solution to wash over the sample. Solution that has passed through the chamber may be collected and retained so that nucleic acid can be extracted from the cells contained therein.

A combination of agitation of the tissue sample and washing of solution over the sample may be employed. For example, the sample could be placed in a chamber or tube system through which solution can be passed and, rather than retaining the tissue sample in position, the tissue may be carried by the flow of the solution. The flow rate may be controlled so as to ensure that the bulk of the tissue sample remains intact. For example, the flow rate may be in the range of about 5-50 ml per second.

In some embodiments, the release of cells may be promoted by enzymatic means. Enzymes may be used in combination with or as an alternative to other means of releasing cells from sample tissue described herein. Proteolytic enzymes and or enzymes that degrade components of the extracellular matrix may be used. Examples include collagenase, protein kinase, trypsin, elastase, hyaluronidase, papain and neutral protease. In such embodiments, minimal or no agitation or tissue washing may be required. The enzyme type, concentration and duration of contact with the tissue sample will be chosen so as to keep the bulk of the tissue sample structure intact. Such enzymes may be present in the solution when the tissue sample is first contacted with the solution or may be added later. The bulk of the tissue sample may be preserved by separating the sample from solution containing the enzyme(s) once a sufficient quantity of cells has been released from the tissue sample. An enzyme inhibitor, which may be specific to an enzyme in the solution, may be added to halt the enzymatic digestion of the tissue sample. Digestive enzymes (proteinase enzymes) may be used at a concentration of about 20 micrograms per ml to about 500 micrograms per ml. The temperature for enzymatic reactions may be about 37° C. to 65° C., for example about 50° C. Enzymatic reactions may be allowed to continue for about 1 hour to about 12-24 hours.

In other embodiments, enzymes are not used to release or promote the release of cells from the tissue sample. In such embodiments, the tissue sample may not be treated or contacted with any enzymes such as proteolytic enzymes, such as trypsin or collagenase to promote the release of cells. In some embodiments the tissue sample is not homogenised or otherwise mechanically disrupted prior to carrying out the method of the invention. In some embodiments, the tissue sample is not dissected or cut further after removal from a subject and before being subjected to the method of the invention.

The desired number of cells to be released from the tissue will depend on the purpose for which the released cells will be used. For example, if DNA is to be obtained from the cells, approximately 250,000 cells may be needed for every 1 microgram of DNA required. Release of cells into solution typically causes the solution to become turbid with cells. Observing an increase in the turbidity of the solution can be used as an indication that sufficient cells have been released into solution. Techniques for measuring turbidity are known in the art, and may include detecting transmission of light through the solution.

Separation of solution from tissue sample

The method of the invention involves separating at least a proportion of the solution from the solid tissue sample. The solution separated from the tissue sample will contain cells derived from the tissue sample. In some embodiments all or substantially all of the solution is separated from the tissue sample. In other embodiments, at least about 99%, 90%, 85%, 80%, 75%, 70%, 65%, 60%, 55%, 50%, 45%, 40%, 35%, 30%, 25%, 20% 15%, 10%, or 5% of the solution is separated from the tissue sample. It may be desirable to isolate a higher proportion of solution from the tissue sample to maximise the quantity of cells in the solution.

Separation of solution from solid tissue sample may be achieved using any suitable means. The tissue sample may be removed from the solution. For example, the tissue sample may be extracted from a container containing the solution, for example using forceps or suction means. Solution may be extracted from a container containing the sample tissue, for example by pouring with or without a filter to catch the tissue or using a pipette or other suction means. If the tissue sample is carried through a chamber or tube system by the solution, separation of solution from the tissue sample may be achieved by retaining the tissue sample in position and draining solution from the chamber or section of tube system in which the tissue sample is retained. Alternatively, the tissue sample could be extracted from the flow of the solution mechanically or by hand. A proportion of the solution may be diverted from the flow of solution carrying the tissue sample and collected. The above examples are not limiting. Other variations will be apparent to the skilled person.

Retaining the Solution

Solution separated from the tissue sample is retained so that the cells released into the solution can be used for testing or other interventions. For example nucleic acid may be extracted from the cells for analysis, for example by subjecting the nucleic acid to a sequencing method. In some embodiments, retaining the solution means that the solution is not discarded until nucleic acid derived from the tissue sample has been collected for analysis. Retaining does not necessarily imply that the solution is stored for any particular length of time. Nucleic acid extraction and/or analysis e.g. sequencing, or any other cell processing, interventions or analysis may be carried out as soon as the solution is separated from the tissue. However, if desired, solution separated from the tissue sample may be stored, for example until a processing method, such as a nucleic acid extraction method, is carried out on cells contained in the solution or until nucleic acids derived from the tissue are analysed for example using a sequencing method. Of course, nucleic acid or other cellular matter may be isolated from the solution before the nucleic acid or other matter is analysed. In this case, the solution may be discarded once the nucleic acid or other matter has been isolated from the solution and/or analysed, e.g. sequenced.

Solution containing cells released from the tissue may be stored at a temperature of from about 2° C. to about 10° C. It is known that DNA can be preserved for at least 72 when it is refrigerated. Therefore, the solution may be stored for up to about 12 hours, about 24 hours, about 36 hours, about 48 hours, about 60 hours, about 72 hours, about 5 days, or about 1 week. The complications of freezing tissue for subsequent extraction of nucleic acid are therefore dispensed with. However, in some embodiments, the solution may be frozen to preserve the cells, or matter released from cells such as DNA, for longer periods of time. Preferably, snap freezing is used to freeze the solution to minimise or prevent damage to the cells.

In some embodiments, cells are separated from the solution and may be frozen for storage. In some embodiments, the solution may be centrifuged to form a cell pellet. The cell pellet may be snap frozen for storage. DNA extraction, for example, can be carried out at a later time.

The cells released into the solution can be used for personalised immunotherapy; testing their response to chemotherapy in vitro; testing their expression of protein or carrying out other laboratory tests which are better carried out with fresh tissue. The cells released into solution may be processed to extract intracellular matter other than nucleic acid, such as proteins, lipids, organelles. In certain embodiments, the cells are used solely for one of these purposes.

In some embodiments, the cells released from the tissue sample are used to establish a cell line. In some embodiments, the cells released from the tissue sample are used for the sole purpose of establishing a cell line. In some embodiments, the cells released from the tissue sample are grown, cultured, or expanded. In some embodiments, cells released from the tissue sample are sorted or separated by cell type.

In some embodiments, the cells released from the tissue sample are not used to establish a cell line. In some embodiments, the cells released from the tissue sample are not grown, cultured, or expanded. In some embodiments, the cells released from the tissue sample are not sorted, or separated by cell type. In some embodiments, the cells obtained from the solid tissue sample are used for the sole purpose of extracting nucleic acid therefrom.

Extraction of nucleic acid

The method of the invention may comprise extracting nucleic acid from cells of the tissue sample. The nucleic acid may comprise or consist of DNA or RNA. Nucleic acid extraction may be carried out after solution containing cells derived from the tissue sample is separated from the tissue sample. In some embodiments, the cells are not subjected to any processing steps between being released from the tissue and nucleic acid extraction. The cells may or may not be subjected to any analysis (such as observation under a microscope) after being released from the tissue sample. Nucleic acid may be extracted from cells within about 1 week, 1 day, 72 hours, about 48 hours, about 36 hours, about 24 hours, about 12 hours, about 6 hours, about 2 hours, about 1 hour, about 45 minutes, about 30 minutes, about 20 minutes, about 10 minutes, about 5 minutes, about 2 minutes or about 1 minute from the solution being separated from the tissue sample. If the solution is frozen this time frame could be extended.

Nucleic acid extraction and isolation techniques are well known in the art. A large number of kits are commercially available e.g. from Qiagen.

It has been found that extracting nucleic acid from cells released into solution according to the method of the invention provides a significantly increased nucleic acid yield per cell compared to the yield achieved when extraction is carried out using whole tissue samples using conventional methods such as homogenisation of the tissue followed by extraction.

Without being limited to any one particular theory, it is believed that the increased yield is achieved for the following reasons. According to existing methods of obtaining DNA from tissue, homogenised/partially homogenised solid tissue (obtained mechanically or otherwise) is applied to a DNA extraction column. Many cells e.g. tumour cells, remain encased in stroma such that their DNA is not accessible. In addition, the DNA extraction columns can be become saturated with the result that residual DNA is washed through and not captured. Applying a solution containing cells obtained according to the method of the invention to a DNA extraction column makes the DNA more accessible for capture in the extraction column and avoids oversaturation of the column.

The solution

Any suitable solution may be used in the present invention. Preferably, the solution is an aqueous solution. The solution may or may not be buffered. Buffered solutions for biological tissue are known to the skilled person. The solution may comprise or consist of a sterile isotonic solution such as PBS; normal saline; Hartmann's solution; Hank's balanced salt solution; dextrose saline. The solution may comprise or consist of a cell culture solution e.g. RPMI (Roswell Park Memorial Institute medium). The solution may comprise or consist of an alcohol-based solution including alcohol-based fixatives e.g. Boonfix; RCL2; KlNfix. The solution may comprise or consist of a methanol-based solution including methanol based fixatives e.g. UMfix. The solution may comprise or consist of DMSO. Other examples of suitable solutions include PAXgene; SurePath; TruePath; PreservCyt; RNAlater.

In a particular embodiment, the solution comprises or consists of phosphate buffered saline (PBS).

In one embodiment, the solution does not comprise any additional agents, such as active agents, for example enzymes.

In other embodiments, the solution may further comprise additional agents such as enzymes. The solution may contain one or more enzymes for promoting the release of cells from the tissue sample as described herein. Enzymes may be present in the solution when the tissue sample is contacted with the solution or may be added later.

In some embodiments, the solution contains laboratory grade sand. This provides an abrasive function and promotes release of cells from the tissue sample. Other similar abrasive materials may be used. Abrasive material may be present in the solution when the tissue sample is contacted with solution, or may be added later.

Analysis of nucleic acids

Nucleic acid obtained from cells of the tissue sample may be analysed. For example, nucleic acid, such as RNA or DNA may be sequenced or used for specific gene testing, either singly or in panels, or may or may not be amplified with PCR using any suitable method. In one embodiment, PCR free whole genome sequencing (WGS) is carried out on nucleic acid obtained from the tissue sample. In one embodiment whole exome sequencing is carried out on nucleic acid obtained from the tissue sample. In one embodiment, DNA is used for gene panel testing or individual gene testing. In one embodiment the whole cells collected are used for FISH testing. Sequencing methods could include next generation whole genome sequencing, bridge PCR and any high throughput sequencing method.

Preservation of solid tissue

One of the advantages of the present invention is that the process of releasing cells from the tissue sample does not disrupt the structure of the tissue sample. Cells are released from the periphery of the tissue sample, leaving the core of the tissue sample intact. The tissue sample therefore remains available for conventional analysis, including any further histopathological investigations necessary for diagnosis. Once solution is separated from tissue sample, the tissue sample may be preserved and/or processed by any conventional means for further analysis. For example, the tissue sample may be preserved in formalin, processed into a paraffin block and then sections made for haematoxylin and eosin staining, special staining or immunohistochemical staining. After separation from the solution, the tissue may be snap frozen, e.g. in liquid nitrogen.

Preferred features of each aspect of the invention are as for each of the other aspects mutatis mutandis. The prior art documents mentioned herein are incorporated to the fullest extent permitted by law.

The invention will now be described in more detail with reference to the accompanying figures and in the following non-limiting examples.

### FIGURES

FIG. 1: Schematic overview of handling of tissue and cell suspensions from Example 1.

FIG. 2: DNA yield from Example 1. The X axis shows DNA yield from single pseudo-biopsies with invasive ductal carcinoma of the breast after a single 1 minute shake (inverting once per second for one minute). Box shows 2^{nd} and 3^{rd} quartiles with black line at median. Plus shows mean. Whiskers show range.

FIG. 3: DNA yield Example 2. The X axis shows DNA yield from single diagnostic biopsies with ductal carcinoma of the breast after a single 1 minute shake (inverting once per second for one minute). Box shows 2^{nd} and 3^{rd} quartiles with black line at median. Whiskers show range.

### Example 1

Rationale

This experiment was designed in order to establish whether shaking tissue in solution would release sufficient cells into solution for whole genome sequencing (WGS).

Outcomes
Morphological assessment of the tissue to ensure it remains suitable for full histological analysis for diagnosis.
Examination of the cells from the suspension to quantify the proportion of malignant cells among those harvested and assess the state of preservation.
DNA yield from the shaken fluid.

Methods

A total of eight patients, consented for research and having surgical resections for breast cancer, were recruited. For six of these patients three diagnostic pseudo-biopsy measuring approximately 15×2×2 mm were cut from the tumour tissue. The seventh patient had a smaller tumour and only one pseudo-biopsy could be cut which was handled as for group B. For the eighth patient no tumour tissue was evident and the three pseudo-biopsies were cut from benign tissue as a control.

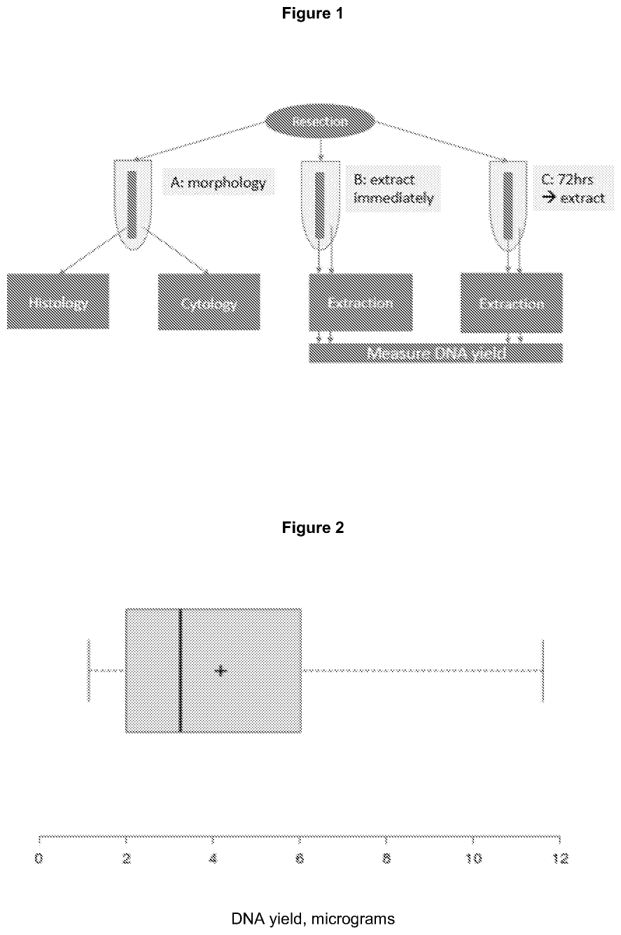

Three pseudo-biopsies were cut and handled in one of three ways, groups A, B and C as set out in FIG. 1. Each pseudo-biopsy was placed into a 1.5 ml Eppendorf tube containing 1 ml of phosphate buffered saline solution. The tube was then gently inverted and righted at a rate of once per second for one minute. The tissue was then removed from the solution.

The tissue from group A was removed and snap-frozen in liquid nitrogen for WGS. The solution was cytospun onto a glass slide for microscopy to examine the type and quality of cells that were removed by shaking. The tissue from group B was formalin fixed and paraffin embedded and a section cut for haematoxylin and eosin staining and examination of the morphology of the remaining tissue after shaking.

The solution from group B was centrifuged at 10,000 rpm for 10 minutes to form a cell pellet. DNA extraction was performed using QIAGEN DNeasy Blood and Tissue Kit, using a modification of the manufacturer's recommended protocol for DNA extraction from Animal Blood or Cells (Spin-Column).

The tissue from group C was also snap-frozen in liquid nitrogen and the solution was kept in the refrigerator for 72 hours at 4° C. before being processed identically to group B.

Results

Tissue Morphology

The tissue biopsies were intact and there was no evidence of the tissue shaking having had an impact on the appearance of the tissue.

Cell Suspension Morphology

The cytological preparations had a high cellularity and contained predominantly intact malignant cells with an appearance and morphological quality similar to that seen in routine diagnostic fine needle aspiration samples.

DNA Yield and Quality

The mean DNA yield from the cell suspensions was 4.0 micrograms with a range of 1.1-11.6 micrograms as shown in FIG. 2. The DNA integrity number for these samples was over 6 for all samples and had a mean of 8 which shows minimal DNA degradation in these samples. The DNA contamination was assessed and the 260/280 ratio fell between 1.74 and 2.04 for all cases, which was the predetermined range for eligibility to be included for whole genome sequencing in the forthcoming NHS Genomic Medicine Service.

The DNA yield from suspensions in group C was reduced compared to group B in five of the six cases. The mean yield from group B was 4.5 micrograms whereas the mean yield from group C was 3.3 micrograms. The difference was not statistically significant. The three pseudo-biopsies cut from benign tissue each yielded less than 1 microgram of DNA.

Discussion

This proof of principle experiment demonstrates that intact cells can be retrieved from a small volume of tissue without deleteriously disrupting the architecture of that tissue. The cells freed into suspension were predominantly intact tumour cells with retained morphology suitable for investigations or testing requiring whole cells. The DNA retrieved from the tissue suspension of group B and C were all of sufficient yield and quality for whole genome sequencing demonstrating one particular utility of this means of harvesting cellular material.

### Example 2

Rationale

To demonstrate that the shaken biopsy technique could successfully retrieve cells from ‘real-life’ diagnostic biopsy tissue, which are smaller and more fragile than pseudo-biopsies and likely to contain a smaller proportion of tumour than the pseudo-biopsy tissue used in Example 1.

Outcomes

DNA yield and quality from shaken cells was assessed and compared with yield and quality from the matched biopsy, and also related to the underlying diagnosis. Frozen sections of the tissue were assessed for diagnosis, tumour content and morphology.

Methods

Thirty patients having radiologically guided breast core biopsy samples in patients with a lesion suspicious for breast cancer were consented for research use of their tissue. Breast cores were taken using a 14 G core biopsy needle. The first core was placed into neutral buffered formalin for fixation. Subsequent cores were placed into a 1.5 ml Eppendorf tube containing 1 ml of phosphate buffered saline. The vial was then inverted and righted at a rate of once per second for a period of 1 minute. The tissue was then removed and snap frozen. The cell suspension was centrifuged at 10,000 rpm for 10 minutes to form a cell pellet. DNA extraction was performed using QIAGEN DNeasy Blood and Tissue Kit, using a modification of the manufacturer's recommended protocol for DNA extraction from Animal Blood or Cells (Spin-Column). The frozen tissue was prepared as a frozen section on a glass slide and stained with haematoxylin and eosin for morphological assessment.

Results

Of the 30 biopsies 23 contained invasive malignancy (one of which was in situ DCIS only) and 7 were benign. Three of the seven cell suspensions from benign tissue yielded over 1 microgram of DNA whereas the other four cell suspensions yielded less than 500 nanograms. 17 of the 23 cell suspensions (74%) from malignant tissue yielded over 500 nanograms which is sufficient for whole genome sequencing in the forthcoming NHS Genomic Medicine Service.

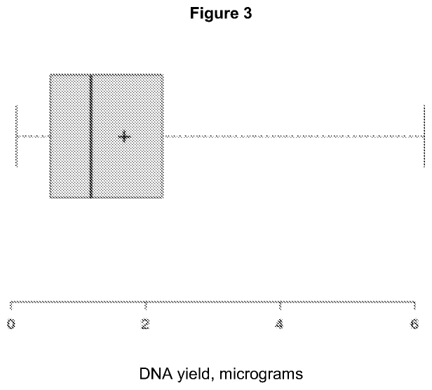

The mean DNA yield from the malignant cell suspensions was 1.9 micrograms with a range of 0.8-6.1 micrograms (see FIG. 3). The DNA integrity number for these samples was over 6 for all samples with over 500 nanograms of DNA and had a mean of 8 which shows minimal DNA degradation in these samples. The DNA contamination was assessed and the 260/280 ratio was outside the 1.74 and 2.04 range for two of the cases with more than 500 nanograms of DNA. Of the total of 23 malignant cases 13 had DNA of sufficient yield and quality for whole genome sequencing based on a single shake (once per second for 1 minute) of a single biopsy.

The frozen sections of the biopsy tissue showed intact architecture with no evidence of the shaking having had a deleterious effect on morphology.

Discussion

This experiment demonstrates that intact cells can be retrieved from biopsy tissue without deleteriously disrupting the architecture of that tissue. The cells freed into suspension were predominantly intact tumour cells with retained morphology suitable for investigations or testing requiring whole cells.

Although this work was carried out on breast cancer samples, it is reasonable to assume the results can be extrapolated to other tumour types. It is an inherent feature of malignant cells that they lose their cell-cell adhesion molecules meaning they are more freely released from the surrounding tissue. This accounts for the difference between the benign and malignant breast tissue cell yield in this experimental work. This is a biological phenomenon that is not tumour type specific.

If greater yield is required, cell suspensions from two or more biopsies could be pooled. Doubling the yields by shaking two biopsies would have resulted in sufficient yield for whole genome sequencing from 19 of the 23 patients.

1. A method for sampling fresh whole cells from a solid tissue sample, the method comprising:
(i) releasing cells from a solid tissue sample into a solution,
(ii) separating at least a proportion of the solution from the solid tissue sample, and
(iii) retaining solution separated from the solid tissue sample.

2. The method of claim 1, wherein the cells are released into the solution by agitating the solid tissue sample in the solution and/or by washing solution over the solid tissue sample.

3. The method of claim 1 or claim 2 wherein retaining the solution comprises storing the solution at a temperature of from about 2° C. to about 10° C.

4. The method of any preceding claim, further comprising extracting nucleic acid from the cells contained in the retained solution.

5. The method of any preceding claim, further comprising analysing nucleic acid of the cells.

6. The method of claim 5, wherein the analysis comprises carrying out a sequencing method on the nucleic acid, such as whole genome sequencing or whole exome sequencing.

7. The method of any preceding claim, wherein the solid tissue sample is retained for diagnostic testing after it has been separated from a proportion the solution in step (ii), optionally wherein the solid tissue sample is preserved, for example by fixing the sample in formalin or by snap freezing.

8. The method of any preceding claim, wherein the solution comprises or consists of phosphate buffered saline (PBS).

9. The method of any preceding claim, wherein cells are released from the tissue sample by agitating the tissue sample for at least 1 minute, or at least 2 minutes.

10. The method of any preceding claim, wherein cells are released from the tissue sample by agitating the tissue sample for no more than 10 minutes.

11. The method of any preceding claim, wherein cells are released from the tissue sample by repeatedly inverting a sample tube containing the solid tissue sample.

12. The method of claim 11, wherein the sample is inverted approximately once per second.

13. The method of any preceding claim, wherein cells are released from the tissue sample by agitating the tissue sample by hand.

14. The method of any preceding claim, wherein cells are released from the tissue sample by automated agitation means.

15. The method of any preceding claim, wherein the solid tissue sample is not subjected to vortexing.

16. The method of any preceding claim, wherein the solid tissue sample is not subjected to sonication.

17. The method of any preceding claim, wherein the solid tissue sample is not subjected to mechanical disruption.

18. The method of any preceding claim, wherein the solid tissue sample is not subjected to treatment with an enzyme.

19. The method of any preceding claim, wherein the solution comprises an abrasive material such as laboratory grade sand.

20. The method of any preceding claim, wherein the solid tissue sample is a tumour tissue sample.
